(19) United States
(12) Patent Application Publication
(10) Pub. No.: US 2025/0175446 A1
(43) Pub. Date: May 29, 2025

(54) Electronic Messaging Systems

(71) Applicant: WELDSECURE LIMITED, St. Peter Port (GB)

(72) Inventors: Bruce McDougall, Guernsey (GB); Tony Cleal, Guernsey (GB); James Martel, Guernsey (GB)

(21) Appl. No.: 18/841,206

(22) PCT Filed: Feb. 27, 2023
(86) PCT No.: PCT/GB2023/050439

§ 371 Date: Aug. 23, 2024

(30) Foreign Application Priority Data
Feb. 25, 2022 (GB) 2202663.7

(51) Int. Cl. H04L 51/212; H04L 51/04

(52) U.S. Cl. CPC H04L 51/212; H04L 51/04

(57) ABSTRACT

An electronic messaging system has multiple user stations and a master station with which the user stations communicate. Each user station is arranged to receive and display electronic messages, receive an input from a user to indicate an alert relating to one of the electronic messages, display a plurality of predetermined reasons for the alert, and receive an input from a user to select at least one of those predetermined reasons. The master station receives alerts from the users of the user stations, along with predetermined reasons that have been selected by the users. In response, the master station issues credits or other rewards or recognition to the users of the user stations. Data from multiple master stations may be fed to a supervisory station interfacing with a processor that functions as a machine learning or artificial intelligence model.

### CROSS-REFERENCE TO RELATED APPLICATIONS

This is the U.S. National Stage application of International Application No. PCT/GB2023/050439, filed Feb. 27, 2023, which claims the benefit of priority from GB 2202663.7, filed Feb. 25, 2022. The entire contents of these prior applications are incorporated by reference.

### FIELD

The present invention relates to electronic messaging systems.

### BACKGROUND

Electronic messaging systems are in worldwide use. For businesses, electronic messages are often sent as emails. However, there are various other formats. A major consideration for all formats of electronic messages is security. At the present time, electronic messages are continually open to compromise.

Malicious actors are conducting cyber-attacks on companies that inflect severe financial and information loss on the victim. One of the most popular attack vectors is phishing electronic messages, whereby the attacker will send an electronic message to an employee with content that is intended to trick the employee into enabling the attack.

### Example Attacks are

1. The electronic message includes a hyperlink or an attachment file that the employee clicks. The result is that malicious software (malware) is downloaded into the victim's computer and into the employer's information technology (IT) network. This then gives the attacker unauthorised access to the computer and network, to compromise the confidentiality, integrity or availability of the information in the network.
2. The electronic message appears to have been sent from a trusted source such as a client or colleague, and contains instructions for the employee to carry out an action such as to make a payment to a supplier. The employee believes the electronic message to be genuine and makes the payment using the bank details provided in the electronic message. The employee is unaware that the electronic message had been sent by a malicious actor impersonating the trusted party, and the payment is made to the attacker.

A current popular practice to reduce the risk of employees falling for phishing electronic messages is to train employees to spot phishing electronic messages, or to test the employee's ability to spot a phishing electronic message by sending them fake versions (known as a phishing simulation test). The common practice by many organisations when the employee ‘fails’ the phishing simulation test, is to force the employee to complete a training module that explains how to spot a phishing electronic message.

The popular practice described above has limited effect in reducing the risk of employees falling for phishing electronic messages because:
Knowledge alone is not enough to change behaviour.
The phishing simulations are a negative experience because they punish the employee for making a wrong decision.
The employee does not benefit from making a discretionary effort to report the electronic message as suspicious and therefore there is no motivation for the employee to help the employer.
The employer does not know the thought process of the employee when they are trying to spot a phishing electronic message and therefore the employer cannot focus their training to address gaps and instead can only give generic training based on what the employer thinks.

### BRIEF SUMMARY

Preferred embodiments of the present invention aim to provide electronic messaging systems that may be improved in the foregoing respects. Such embodiments employ technical means that help to engage employees in defeating cyber-attacks and help to improve upstream filtering of electronic messages. In this way, security of electronic messaging systems may be improved.

Preferred embodiments of the invention aim to identify electronic messages that may be malicious by analysing information using machine learning (ML) and/or artificial intelligence (AI) to further enable the identification of similar characteristics in other potentially malicious electronic messages. The objective of this is to achieve a technical effect of increasing cyber security through application of this analysis to inform other technical systems—for example, to prevent the delivery of potentially malicious electronic messages.

According to one aspect of the present invention, there is provided an electronic messaging system comprising a plurality of user stations and a master station with which all of the user stations communicate, wherein:
each of the user stations is arranged to:
   receive and display electronic messages;
   receive an input from a user to indicate an alert relating to one of said electronic messages;
   display a plurality of predetermined reasons for the alert; and
   receive an input from a user to select at least one of said
predetermined reasons: and
the master station is arranged to:
   receive alerts from the users of the user stations, along with respective predetermined reasons that have been selected by the users; and
   issue credits or other rewards or recognition to the users of the user stations, in response to receiving alerts and selected reasons from the users.

Preferably, the electronic messaging system further comprises a first processor that is arranged to receive data relating to the predetermined reasons received by the master station, and rank the predetermined reasons in order of use.

Preferably, each of the user stations is arranged to display the predetermined reasons in an order determined by the ranking carried out by the first processor.

Preferably, each of the user stations is arranged to receive free text input from a user to indicate a further reason for the alert, in addition to or as an alternative to said predetermined reasons, and the master station is arranged to receive said free text from the users of the user stations.

Preferably, the electronic messaging system further comprises a second processor that is arranged to receive and analyse data relating to said free text and to provide an output that may be used to inform other systems in order to improve the security of electronic messaging systems.

Preferably, the electronic messaging system further comprises a third processor that is arranged to receive data generated from other processors, including other data such as metadata, and to analyse that data using machine learning or artificial intelligence to provide an output to inform other systems in order to improve the security of electronic messaging systems.

Preferably, the outputs of the second and third processors are used to add one or more reason to the predetermined reasons that are displayed on the user stations.

Preferably, electronic messages associated with alerts received from users of the user stations are assessed at the master station and, where such an electronic message is assessed as suspicious, an additional credit or other reward or recognition is issued to the respective user.

Preferably, the electronic messaging system further comprises a plurality of master stations as aforesaid, each with its own group of user stations, and a supervisory station that is arranged to receive data from all of the master stations and process the data received from the master stations to provide an output to inform other systems in order to improve the security of electronic messaging systems.

The electronic messages may include communications such as email, instant messaging, chat or collaboration tools, communication platforms, or other similar electronic messages.

In another aspect, the invention comprises a method of operating an electronic messaging system comprising a plurality of user stations and a master station with which all of the user stations communicate, including the steps of:
receiving and displaying electronic messages at each of the user stations;
receiving inputs from users of the user stations to indicate alerts relating to said electronic messages;
displaying to the users a plurality of predetermined reasons for the alerts;
receiving inputs from the users to select at least one of said predetermined reasons;
receiving at the master station alerts from the users of the user stations, along with respective predetermined reasons that have been selected by the users; and
issuing credits or other rewards or recognition to the users of the user stations, in response to receiving alerts and selected reasons from the users.

Preferably, the method includes the further steps of:
receiving free text inputs from the users to indicate a further reason for the alert and a master station arranged to receive said free text from the users of the user stations in addition to or as an alternative to said predetermined reasons;
adding one or more reason to the predetermined reasons that are displayed on the user stations;
receiving and analysing data relating to said free text and to provide an output that may be used to inform other systems in order to improve the security of electronic messaging systems; and
receiving data generated from other processors, including other data such as metadata, and analysing that data using machine learning or artificial intelligence to provide an output to inform other systems in order to improve the security of electronic messaging systems.

Preferably, the method is carried out by an electronic messaging system according to any of the preceding aspects of the invention.

### BRIEF DESCRIPTION OF THE DRAWINGS

For a better understanding of the invention, and to show how embodiments of the same may be carried into effect, reference will now be made, by way of example, to the accompanying diagrammatic drawings, in which:

FIG. 1 is a diagram of an electronic messaging system having a plurality of user stations and a master station;

FIG. 2 is a diagram of an electronic messaging system having a plurality of master stations and a supervisory station; and

FIG. 3 illustrates one example of a multiple-choice input window.

In the figures, like references denote like or corresponding parts.

### DETAILED DESCRIPTION

It is to be understood that the various features that are described in the following and/or illustrated in the drawings are preferred but not essential. Combinations of features described and/or illustrated are not considered to be the only possible combinations. Unless stated to the contrary, individual features may be omitted, varied or combined in different combinations, where practical.

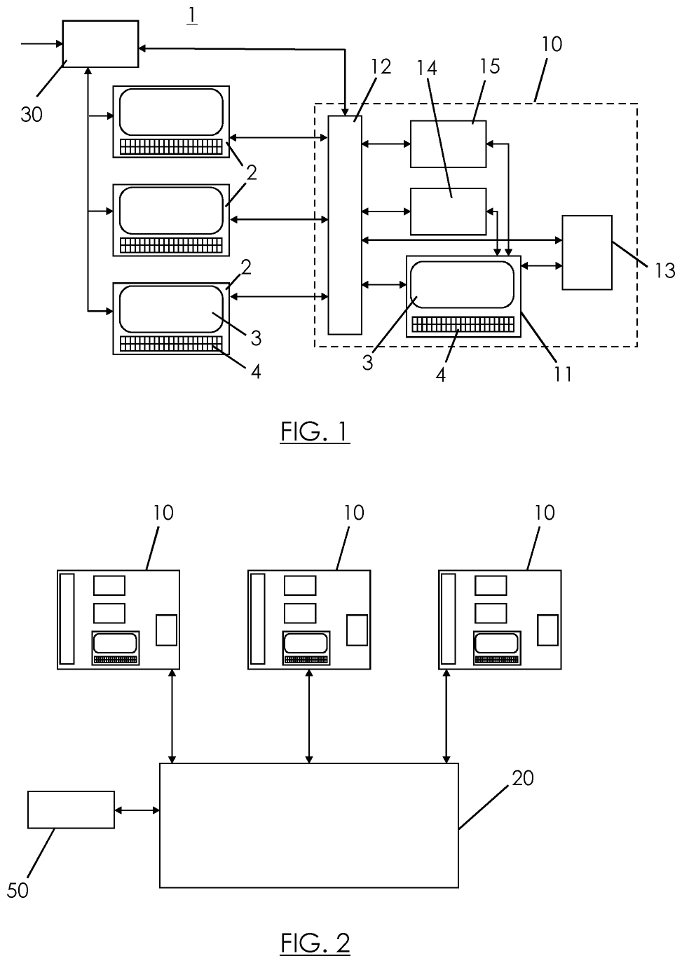

The electronic messaging system 1 shown in FIG. 1 comprises a plurality of user stations 2 that communicate with a master station 10. Some or all of the user stations 2 and master station 10 may be in a common location, or they may be at locations that are remote from one another.

Each of the user stations 2 comprises one or more processor, a screen 3 and a keyboard 4 (physical or virtual). Each user station 2 is arranged to receive and send emails (and/or electronic messages in other formats). Typically, each user station 2 may comprise a PC, laptop or handheld device, such as a smartphone or tablet.

The master station 10 comprises a screen 3, keyboard 4 (physical or virtual), central processing unit 11, I/O module 12, store 13, first processor stage 14 and second processor stage 15. The first and second processor stages 14, 15 are shown separately to facilitate explanation but, in practice, may be incorporated in the central processing unit 11.

The user stations 2 may be arranged to perform various processor-based tasks. However, the focus of this embodiment of the invention is the electronic messaging system 1 of which they form part and which, by way of example, is an electronic message system.

The electronic message system 1 comprises an upstream filter 30 that passes incoming electronic messages to the user stations 2 and is configured to delete or quarantine electronic messages that meet predetermined criteria to indicate that the electronic messages are malicious. In this example, the user stations 2 receive incoming electronic messages from a common filter 30. However, each user station 2 could alternatively have its own upstream filter 30 that is configured in a similar way to the other filters 30.

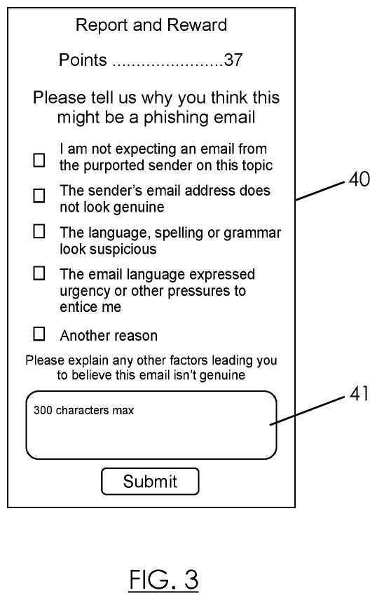

When a user identifies an incoming email communication as potentially malicious—in this example, a ‘phishing’ electronic message—the user activates a key to indicate an alert relating to the electronic message. Upon receiving an input generated in response to the alert, the respective user station 2 causes a multiple-choice input window, and/or a re-formatted version of the communication in order that the user can indicate the text and areas of concern, to be displayed on the screen 3. One example of such a window 40 is shown in FIG. 3.

The window 40 displays a plurality of predetermined possible reasons for the alert, each with a respective check box. If the user identifies one of the predetermined reasons as the reason for the alert, the user checks the respective check box and presses the Submit button, which causes data that identifies the electronic message and the respective predetermined reason to be transmitted to the master station 10. It is possible to select more than one predetermined reason and to associate that reason with a specific text in the electronic message.

It is also possible to enter free text in a sub-window 41, to indicate a further reason for the alert, in addition to or as an alternative to the displayed predetermined reasons. Data representing such free text is then transmitted to the master station 10, along with the other relevant data.

Upon receiving alert data, along with data to indicate a valid respective reason for the alert, the master station 10 automatically increments a credit or other reward or recognition score for the respective user, which score is maintained in store 13. Data representing the updated credit score is then transmitted to the respective user station 2.

In one option, the master station 10 automatically increments a credit or other reward or recognition score for the respective user, upon receipt of an alert and a selected reason for it, irrespective of whether the selected reason is correct. In another option, the master station 10 provides automated machine review or manual review by a third party of the selected reason and associated electronic message, to ensure that there is sufficient correspondence between the selected reason and the electronic message, before incrementing the credit or other reward or recognition score.

In the example illustrated in FIG. 3, the respective user has a credit or other reward or recognition score shown as 37 points. This may be redeemed by the user to receive a reward. Examples of rewards include a product from an online catalogue, additional annual leave/holiday, or a donation to a charity or corporate social responsibility (CSR) initiative, or a higher status in a league table amongst colleagues or other users.

It will be appreciated that the system, as described so far, provides an incentive for a user to report suspicious emails. Users are encouraged to report suspicious electronic messages, not only by the prospect of credits or other rewards or recognition rewards, but by ease-of-use of the system. By displaying predetermined reasons for alerts with an optional reformatted version of the electronic message, the system is at least semi-automatic. The user simply has to check a box and press the Submit button.

It is an important objective to encourage users to report suspicious electronic messages, since this provides essential data to develop and refine security measures of the electronic message system.

In this example, the first processor stage 14 of the master station 10 receives data relating to the predetermined reasons received by the master station 10 from the various user stations 2 and ranks the predetermined reasons in order of use. It will be appreciated that this is a continuous process, reflecting which types of phishing electronic messages are most active at any particular time. Security professionals will know that the types of such malicious electronic messages can vary with time.

Data from the first processor stage 14 is communicated to the user stations 2 so that, at any given time, the predetermined reasons for alerts are displayed in the window 40 in the order determined by the ranking carried out by the first processor stage 14. Thus, if at any given time there is a burst of activity with a certain type of phishing electronic message, the characterising reason for that type of electronic message is displayed first in the window 40. This helps to continuously train the users, who will repeatedly see the most usual reasons for alerts, in order of ‘popularity’.

Ranking of the predetermined reasons in order of use is an optional feature. An operator might decide that the list of reasons might be static or might change based on some other criteria. Alternatively or additionally, an operator might decide to jumble up the list of reasons now and again, in order that users cannot predict the sequencing of reasons and are therefore kept on their toes.

In this example, an additional optional feature is that the second processor 15 of the master station 10 receives data relating to free text input via the sub-windows 41 and provides an output indicative of repetitive occurrences of common text in separate instances of such free text. Thus, the system is able to learn new reasons for alerts and, once a new reason has been established, the output of the second processor 15 is used to add one or more reason to the predetermined reasons that are displayed on the user stations 2. Also, data that relates to the new reasons for the alerts is fed to the upstream filter 30, to provide improved upstream filtering of electronic messages to remove or quarantine suspicious electronic messages.

Where a user at a user station 2 submits free text that is assessed at the master station 10 as indicating a suspicious electronic message, the master station 10 may optionally increment an additional credit or other reward or recognition for the user, maintained in store 13. Data representing the updated credit or other reward or recognition score is transmitted to the respective user station 2. This further encourages users to inspect electronic messages carefully and submit yet further useful data concerning suspicious electronic messages, to facilitate both machine learning in the system and manual training for users, based on data that is both up-to-date and being continually updated.

Advantageously, the master station 10 may be arranged to analyse the alerts by users of the user stations, and other data from other sources both proprietary and non-proprietary, based on modelling and algorithms to identify similar characteristics in other potentially malicious electronic messages.

In the system illustrated in FIG. 2, a plurality of master stations 10 communicate with a supervisory station 20. Each master station 10 also communicates with a plurality of user stations 2, as described above, but in the interests of clarity, the user stations 2 are not reproduced in FIG. 2.

The supervisory station 20 may function in a similar way to the master stations 10, although the functioning and maintenance of the user credit or other reward or recognition may be left largely to the master stations 10. Because the supervisory station 20 receives data from a plurality of master stations 2, it can process that data to provide an output representative of the ranking of alert reasons over all of the users-which may be a significantly larger number of users than in the case of a single master station 10. The user stations 2 can then be updated accordingly with predetermined alert reasons based on data that is both up-to-date and continually updated.

Likewise, data representing free text submitted by a large number of users is assessed at the supervisory station 20. Data that relates to new reasons for the alerts is then fed to upstream filters 30, to provide improved upstream filtering of electronic messages to remove or quarantine suspicious electronic messages.

The supervisory station 20 may interface with a third processor 50 that functions as a machine learning or artificial intelligence model, configured to receive and analyse data from the master stations 10—for example, to train a machine learning model that may be used to provide predictive data to inform other systems including the upstream filter 30, in order to improve the security of electronic messaging systems.

In FIG. 2, the master stations 10 may represent different departments in an organisation in which the supervisory station 20 is also located. Alternatively, the master stations 10 may represent different organisations, with the supervisory station 20 run by an independent organisation to which the different organisations subscribe to receive data from the supervisory station 20 in order to keep their security technology up-to-date and continually updated.

Although, for convenience, embodiments of the invention have been described with reference to employees and employers, it will be appreciated that electronic messaging systems in accordance with the invention may be adopted in any situation where there are a plurality of user stations, one or more master station and, optionally, a supervisory station.

Whilst embodiments of the invention as illustrated and described above are given in the context of electronic message systems, other embodiments may process electronic messages in other formats. For example, recent threat intelligence shows that cyber-attackers are focussing upon electronic messages in the Microsoft Teams (RTM) format.

It will be appreciated that, by adopting embodiments of the invention as illustrated and described above, security of electronic messaging systems may be markedly improved.

Whilst a significant advantage of such embodiments is to provide a system that operates at least semi-automatically, it will be appreciated that operators of the system can obtain and review data captured by the system in order to understand what attacks are going on, what employees understand, and how employee training may be improved. The system can adopt known technology solutions to provide machine analysis of reported electronic messages, including the user of artificial intelligence and machine learning. Such analysis can be utilised to improve automatic filtering of incoming electronic messages, as may be adopted in the upstream filters 30, for example.

In this specification, the verb “comprise” has its normal dictionary meaning, to denote non-exclusive inclusion. That is, use of the word “comprise” (or any of its derivatives) to include one feature or more, does not exclude the possibility of also including further features. The word “preferable” (or any of its derivatives) indicates one feature or more that is preferred but not essential.

All or any of the features disclosed in this specification (including any accompanying claims, abstract and drawings), and/or all or any of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-15. (canceled)

16. An electronic messaging system for enhancing cyber security, the electronic messaging system comprising a plurality of user stations and a master station with which all of the user stations communicate over an information technology network, wherein:
(a) each of the user stations is arranged to:
receive and display electronic messages containing a possible cyber-attack at the user station;
receive an input from a user to indicate an alert relating to one of said electronic messages containing the possible cyber-attack;
display a plurality of predetermined reasons for the alert at the user's user station; and
receive an input from the user to select at least one of said predetermined reasons; and
(b) the master station is arranged to:
receive the alerts from the user stations, along with the respective predetermined reasons that have been selected by the users; and
issue credits or other rewards or recognition to the users of the user stations, in response to receiving alerts and selected reasons from the users.

17. The electronic messaging system of claim 16, further comprising a first processor that is arranged to receive data relating to the predetermined reasons received by the master station and rank the predetermined reasons in order of use based on which types of phishing electronic message are most active at that time.

18. The electronic messaging system of claim 17, wherein each of the user stations is arranged to display the predetermined reasons in an order determined by the ranking carried out by the first processor.

19. The electronic messaging system of claim 16, wherein each of the user stations is arranged to receive free text input from a user to indicate a further reason for the alert, in addition to or as an alternative to said predetermined reasons, and the master station is arranged to receive said free text from the users of the user stations.

20. The electronic messaging system of claim 19, further comprising a second processor that is arranged to receive and analyze data relating to said free text and to provide an output to inform other systems in order to improve the security of electronic messaging systems.

21. The electronic messaging system of claim 16, further comprising a third processor that is arranged to receive data generated from other processors, including metadata, and to analyze the data using machine learning or artificial intelligence to provide an output to inform other systems in order to improve the security of electronic messaging systems.

22. The electronic messaging system of claim 21, further comprising a third processor that is arranged to receive data generated from other processors, including metadata, and to analyze the data using machine learning or artificial intelligence to provide an output to inform other systems in order to improve the security of electronic messaging systems, wherein the outputs of the second and third processors are used to add one or more reasons to the predetermined reasons that are displayed on the user stations.

23. The electronic messaging system of claim 16, wherein electronic messages associated with alerts received from users of the user stations are assessed at the master station and, where such an electronic message is assessed as suspicious, an additional credit or other reward or recognition is issued to the respective user.

24. The electronic messaging system of claim 16, comprising a plurality of the master stations, each with its own group of user stations, and a supervisory station that is arranged to receive data from all of the master stations and process the data received from the master stations to provide an output to inform other systems in order to improve the security of electronic messaging systems.

25. The electronic messaging system of claim 16, wherein the electronic messages include email, instant messaging, chat, collaboration tools, and/or communication platforms.

26. A method of operating an electronic messaging system for enhancing cyber security comprising a plurality of user stations and a master station with which all of the user stations communicate over a network, including the steps of:
receiving and displaying electronic messages containing a possible cyber-attack at each of the user stations;
receiving inputs from users of the user stations to indicate alerts relating to said electronic messages containing the possible cyber-attack;
displaying to the users a plurality of predetermined reasons for the alerts at the user stations;
receiving inputs from the users to select at least one of said predetermined reasons;
receiving, at the master station, the alerts from the user stations, along with respective predetermined reasons that have been selected by the users; and
issuing credits or other rewards or recognition to the users of the user stations, in response to receiving alerts and selected reasons from the users.

27. The electronic messaging system of claim 26, including the further steps of:
receiving free text inputs from the users to indicate a further reason for the alert and a master station arranged to receive said free text from the users of the user stations in addition to or as an alternative to said predetermined reasons;
adding one or more reason to the predetermined reasons that are displayed on the user stations;
receiving and analyzing data relating to said free text and to provide an output that may be used to inform other systems in order to improve the security of electronic messaging systems; and
receiving data generated from other processors, including metadata, and analyzing that data using machine learning or artificial intelligence to provide an output to inform other systems in order to improve the security of electronic messaging systems.

28. The method of claim 26, carried out by the electronic messaging system of claim 16.
